(19) United States
(12) Patent Application Publication
(10) Pub. No.: US 2019/0277286 A1
(43) Pub. Date: Sep. 12, 2019

(54) STATOR, ROTARY SHAFT, DRY VACUUM PUMP AND ASSOCIATED MANUFACTURING PROCESSES

(71) Applicant: PFEIFFER VACUUM, Annecy (FR)

(72) Inventor: Eric MANDALLAZ, Annecy (FR)

(73) Assignee: PFEIFFER VACUUM, Annecy (FR)

(21) Appl. No.: 16/302,926

(22) PCT Filed: May 17, 2017
(86) PCT No.: PCT/EP2017/061892

§ 371 Date: Nov. 19, 2018

(30) Foreign Application Priority Data
May 24, 2016 (FR) 1654650

(51) Int. Cl. F04C 18/12; F04C 25/02; F16C 3/02

(52) U.S. Cl. CPC F04C 18/123; F04C 18/126; F04C 25/02; F16C 3/02; F16C 2220/02; F04C 2240/60; F04C 2280/04; F05C 2201/0466; F16C 2204/52; F04C 2220/12

(57) ABSTRACT

A stator of a dry vacuum pump is provided, the pump having at least two rotors to rotate in a synchronised manner in opposite directions in a central housing to drive a gas to be pumped between a suction inlet and a delivery outlet, the stator including an outer part made of cast iron containing less than 5% nickel, and a stator insert wherein is arranged the central housing configured to receive the at least two rotors, the stator insert containing at least 10% nickel, the outer part of the stator having been cast on the stator insert. There is also provided a rotary shaft configured to bear and drive in rotation at least one rotor of a vacuum pump, a dry vacuum pump having at least one such stator and/or at least one such shaft, and a method for manufacturing such a stator and/or such a rotary shaft.

The present invention relates to a stator of a dry vacuum pump. The present invention also relates to a rotary shaft configured to bear and drive in rotation at least one rotor of a vacuum pump. The invention also relates to a dry vacuum pump having at least such a stator and/or at least such a shaft, such as a vacuum pump of “Roots” or “Claw” type, or even of spiral type or screw type or of another similar principle. The invention also relates to a process for manufacturing such a stator and/or rotary shaft.

Certain manufacturing processes, such as the manufacture of integrated circuits, photovoltaic solar cells, flat panel display screens, and light-emitting diodes, feature steps to remove corrosive, reactive gases coming from process chambers. Dry vacuum pumps are used, the inlet of which is connected to the process chamber and the outlet is connected to gas processing devices prior to the release of the processed gases into the atmosphere.

The gas drawn at the inlet of the pump is trapped in the free space between the stator and two rotors rotating in opposite directions and is delivered to the outlet. The operation is carried out without any mechanical contact between the rotors and the stator but via very small clearances, which allows completely oil-free operation.

The stator and the rotors are parts generally made of cast iron.

The surfaces of these parts can corrode due to the action of the reactive gases drawn in, such as fluorine, chlorine and oxygen. Corrosion layers can thus form on the surface of the parts, thereby reducing the operating clearances between the rotors and the stator, modifying the performance characteristics of the vacuum pump and, in the worst case, cause the pump to seize.

Ni-resist type, nickel-enriched, cast irons have the advantage of being much more resistant to corrosion and oxidation than traditional cast irons. However, this material can not be easily substituted for conventional cast iron to produce vacuum pump parts owing to its very high cost and its lower mechanical performance. This material is also difficult to machine. In addition, nickel is becoming increasingly rare on Earth, and its environmental impact is more detrimental than that of the elements of conventional cast irons.

A known solution to limit the use of this material consists in depositing, on the conventional iron, thin layers of nickel to a thickness of just a few tens of microns.

The application of this solution in the field of vacuum pumps poses problems inherent in this technology.

The nickel coating does not sufficiently adhere to conventional cast iron. The latter can become scratched or tear locally at the slightest impact or touch of the coating. The conventional cast iron substrate under the coating can then be rapidly exposed to corrosive gases causing the superficial layer of nickel to separate locally.

Furthermore, the metallic particle removed from the coating can become reattached on other nickel surfaces elsewhere in the vacuum pump body, leading to a subsequent risk of pump seizure.

Other types of castings or coatings have also been considered to form the material of the rotors and of the stator, such as Silicon and Molybdenum (SiMo) based ductile cast iron alloys or ADI cast iron (Austempered Ductile Iron) or polymer coatings such as Teflon, these solutions, however, not being truly satisfactory owing to the poor adhesion of the coating or the cost of these materials.

The present invention aims to at least partially remedy the aforementioned drawbacks.

One of the objects of the invention is to provide a vacuum pump that resists corrosive gases, which is not too expensive and has good mechanical strength.

To this end, the subject of the invention is a dry vacuum pump stator, the vacuum pump comprising at least two rotors capable of rotating in a synchronised manner in opposite directions in a central housing of the stator to drive a gas to be pumped between a suction inlet and a delivery outlet of the stator, characterized in that the stator comprises:
An outer part of the stator made of cast iron containing less than 5% nickel, such as for example less than 1% nickel and
a stator insert in which is arranged the central housing configured to receive the rotors of the vacuum pump, the stator insert containing at least 10% nickel, such as at least 30% nickel, such as for example containing at least 35% nickel,
the outer part of the stator having been cast on the stator insert.

The stator is thus formed from two solid parts of different materials. The core of the stator, which is likely to come into contact with the corrosive gases, is thus formed in a material that is more corrosion resistant. The material of the outer part, on the other hand, has greater mechanical strength. The vacuum pump thus has greater resistance to corrosive gases while exhibiting good mechanical strength. In addition, the use of nickel is targeted and therefore limited.

By casting cast iron containing less than 5% nickel on the stator insert, the outer part of the stator and the stator insert are locally fused together. During the casting operation, an intimate metallurgical bond is thus formed between the stator insert and the outer part of the stator. This makes it possible to solve the problem of the different thermomechanical behaviours of the two materials. The metallurgical bond is thus extremely mechanically strong. This strong metallurgical bonding makes “release” of the two parts impossible.

According to one or more characteristics of the stator, taken alone or in combination:
the outer part of the stator surrounds the stator insert,
at least one interstage duct communicating with the central housing is at least partially arranged in the stator insert,
the stator insert is an alloy, such as a cast iron, such as spheroidal graphite cast iron, containing at least 10% nickel, such as containing at least 30% nickel,
the stator insert is made of nickel, i.e. it substantially containing 100% nickel,
the outer part of the stator is made of cast iron, such as a spheroidal graphite cast iron,
the outer wall of the stator insert is devoid of threads, grooves, knurling or other elements with relief which present a snagging risk.

The invention also relates to a dry vacuum pump having at least one pumping stage for driving a gas to be pumped between a suction inlet and a delivery outlet, characterized in that it has at least one stator as described above.

The vacuum pump may include a plurality of pump stages coupled in series. The at least one pumping stage having a stator as described above, can be located on the delivery side of the vacuum pump.

According to one or more characteristics of the vacuum pump, taken alone or in combination:
the vacuum pump further has a rotary shaft configured to bear and rotate at least one rotor, the rotary shaft having:
   a shaft insert made of cast iron containing less than 5% nickel, and
   an outer part of the shaft intended to bear at least one rotor of the vacuum pump, the outer part of the shaft containing at least 10% nickel,
   the shaft insert having been cast in the outer part of the shaft,
the outer part of the shaft radially surrounds the shaft insert,
the radial thickness of the outer part of the shaft is greater than 0.5 centimetres.

The invention also relates to a method of manufacturing a dry vacuum pump stator, characterized in that it has the following steps:
a stator insert is first formed containing at least 10% nickel, such as containing at least 30% nickel, such as containing at least 35% nickel, for example,
then, an outer part of the stator made of cast iron containing less than 5% nickel, such as containing, for example, less than 1% nickel, is cast on the stator insert.

According to one or more characteristics of the process for manufacturing a dry vacuum pump stator, taken alone or in combination:
the stator outer part is made of ferritic spheroidal graphite cast iron whose casting temperature is higher than 1300° C.,
before the cast iron containing less than 5% nickel is cast, the roughness of the outer wall of the stator insert is between 6 and 12 micrometres.

The invention also relates to a rotary shaft for a dry vacuum pump having at least one stator and at least two rotors capable of rotating in a synchronised manner in opposite directions in the stator in order to drive a gas to be pumped between a suction inlet and a delivery outlet, the rotary shaft being configured to bear and drive at least one rotor in rotation, characterized in that the rotary shaft has:
a shaft insert made of cast iron containing less than 5% nickel, such as containing, for example, less than 1% nickel, and
an outer part of the shaft intended to bear at least one rotor of the vacuum pump, the outer part of the shaft containing at least 10% nickel, such as containing at least 30% nickel, such as containing at least 35% nickel, for example,
the shaft insert having been cast in the outer part of the shaft.

Such a solid outer part of the shaft makes it possible to prevent corrosive gases from reaching the conventional cast iron in the event of mechanical impacts to the surface of the shaft. On the contrary, in the event of impacts, the corrosive gases continue to be in contact with the nickel-enriched alloy or the nickel. The outer part of the shaft can thus be subjected to small impacts and abrasions without lowering its level of protection against corrosive gases. Furthermore, owing to this solid aspect of the outer part of the shaft, it is possible to remachine the parts possibly damaged during maintenance of the vacuum pump.

According to one or more characteristics of the shaft, taken alone or in combination:
the outer part of the shaft radially surrounds the shaft insert,
the radial thickness of the outer part of the shaft is greater than 0.5 centimetres,
the outer part of the shaft is an alloy, such as cast iron, such as a spheroidal graphite cast iron, containing at least 10% nickel, such as containing at least 30% nickel, such as, for example, containing at least 35% nickel,
the outer part of the shaft is made of nickel, i.e. containing substantially 100% nickel,
the shaft insert is made of a cast iron, such as spheroidal graphite cast iron,
the internal wall of the outer part of the shaft is devoid of threads, grooves, knurling or other elements with relief which present a snagging risk.

The invention also relates to a dry vacuum pump having at least one pumping stage for driving a gas to be pumped between a suction inlet and a delivery outlet, characterized in that it has at least one rotary shaft as described above.

The invention also relates to a method of manufacturing a rotary shaft of a dry type vacuum pump, characterized in that it has the following steps:
an outer part of the shaft of general tubular shape is first formed containing at least 10% nickel, such as containing at least 30% nickel, such as containing at least 35% nickel, for example,
then a shaft insert made of cast iron containing less than 5% nickel, such as containing, for example, less than 1% nickel, is cast into the outer part of the shaft.

According to one or more characteristics of the process for manufacturing a dry vacuum pump rotary shaft, taken alone or in combination:
the shaft insert is made of ferritic spheroidal graphite cast iron, whose casting temperature is higher than 1300° C.,
before casting the cast iron containing less than 5% nickel, the roughness of the inner wall of the outer part of the shaft is between 6 and 12 micrometres.

Other characteristics and advantages of the invention will become more apparent from the following description, given as a non-limiting example, with reference to the accompanying drawings, wherein:

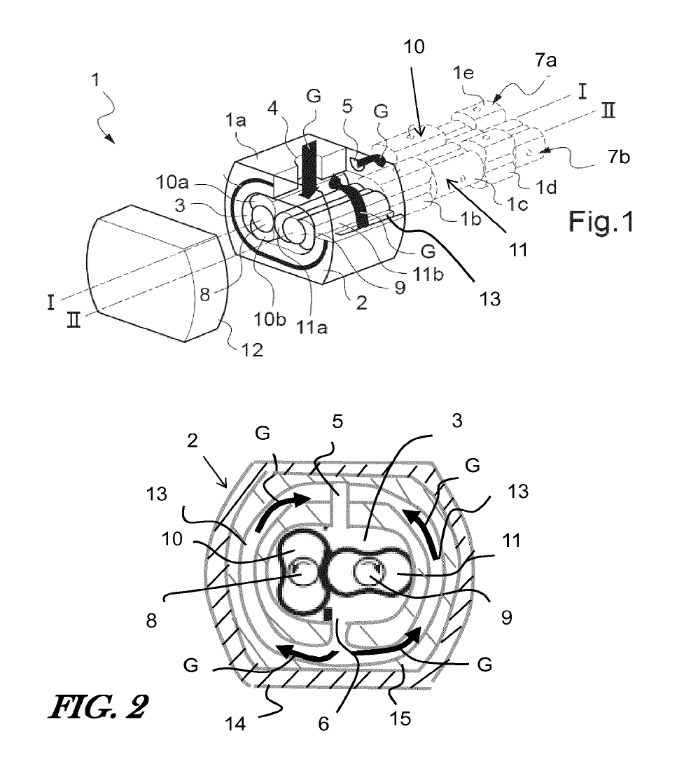

FIG. 1 represents a schematic view of the elements of a multi-stage roots-type dry vacuum pump.

FIG. 2 represents a cross-sectional schematic view of a pumping stage of the vacuum pump of FIG. 1.

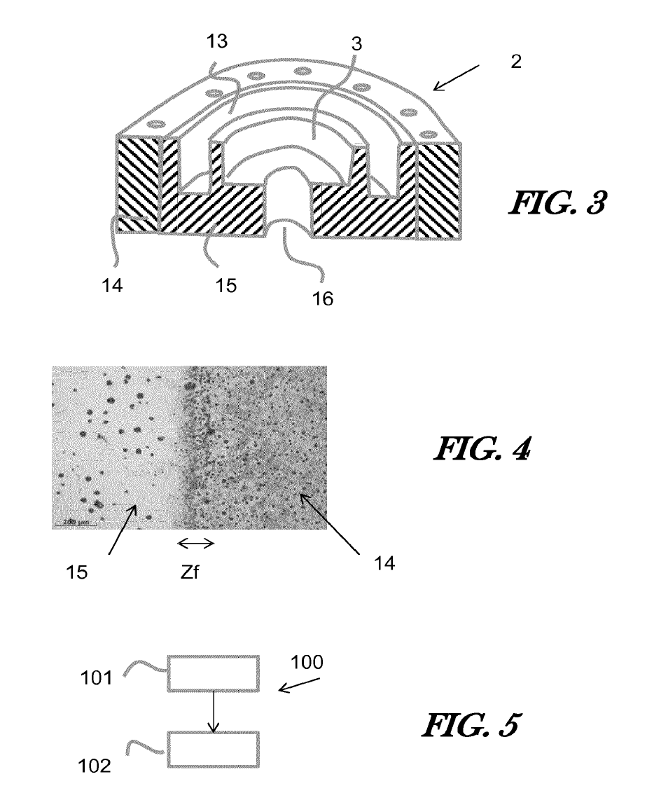

FIG. 3 represents longitudinal cross-section schematic view of a stator of the pumping stage of FIG. 2.

FIG. 4 represents a photography, taken during a magnetic particle examination, of a sample performed in the fusion zone between an outer part of the stator and a stator insert.

FIG. 5 shows various steps of the process for manufacturing a stator or a rotary shaft.

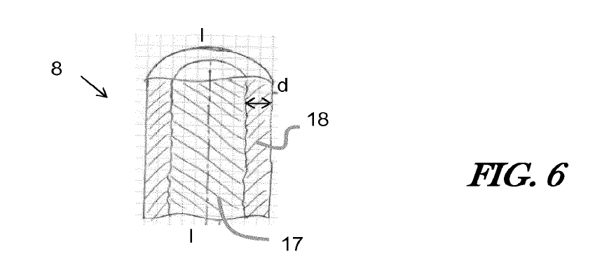

FIG. 6 shows a partial, cross-sectional schematic view of a rotary shaft of the vacuum pump of FIG. 1.

In these figures, identical elements bear the same reference numbers.

The following embodiments are examples. While the description refers to one or more embodiments, this does not necessarily mean that each reference relates to the same embodiment or that the features apply only to a single embodiment. Simple features of different embodiments may also be combined or interchanged to provide other embodiments.

The invention applies to any type of dry vacuum pump having one or more stages, such as a “Roots” type vacuum pump, a double “Claw”, spiral, screw type vacuum pump or of another similar principle, notably used in certain manufacturing processes, such as the manufacture of integrated circuits, photovoltaic solar cells, flat panel display screens, light emitting diodes, these processes comprising steps requiring the removal of corrosive reactive gases from process chambers, the inlet of the vacuum pump being connected to the process chamber and the outlet being connected to gas processing devices, prior to the release of the treated gases into the atmosphere.

FIG. 1 thus illustrates an embodiment of a Roots type multistage dry vacuum pump 1. For clarity, only the elements required for the operation of the pump were represented.

The vacuum pump 1 has five pumping stages 1a, 1b, 1c, 1d and 1e, each stage 1a-1e having a stator 2, of which only three-fourths of the first stage 1a are shown in FIG. 1. The stators 2 are assembled by a fastening screw, for example, to form a one-piece body of the vacuum pump 1.

The pumping stages 1a-1e are placed in series one after the other and are connected in series one after the other by interstage ducts 13, which are arranged laterally here.

As can be seen in the schematic representation of FIG. 2, the interstage ducts 13 are formed in the body of the stator 2. They connect the delivery outlet 6 of a central housing 3 of a pumping stage to the inlet 5 of the following stage. There are, for example, two interstage ducts 13 per pumping stage 1a-1e, connected in parallel between the outlet 6 and the inlet 5 and arranged on either side of the central housing 3.

The pump 1 also has two rotor assemblies 7a, 7b each having a rotary shaft 8, 9, respectively.

The shafts 8, 9 are mounted in parallel and extend into the pumping stages 1a-1e. They are driven by a motor in rotation about an axis of rotation I-I and II-II, respectively, and can be mounted on ball bearings borne by flanges 12 located at the ends of the vacuum pump 1 (only one of which is shown).

Each shaft 8, 9 bears a rotor 10, 11 in each pumping stage 1a-1e. Each rotor 10, 11 is, for example, formed by two rotating half-lobes 10a, 10b and 11a, 11b attached and secured to the shafts 8, 9, respectively, by retaining screws (FIG. 1).

The rotors 10, 11 have identical profiles, each having a general eight-shaped cross-section, for example (FIG. 2). The rotors 10, 11 are angularly offset and driven to rotate synchronously in the opposite direction in the central housing 3 of each stage.

During the rotation of the rotors 10, 11, the gas, drawn in through a suction inlet 4, 5 of the stator 2, is trapped in the free space between the rotors 10, 11 and the stator 2, and then is driven by the rotors 10, 11 to the next stage upstream in the lateral interstage ducts 13 to join the inlet 5 arranged in the upper part of the next pumping stage. After the last pumping stage 1e, the drawn gases are driven towards the general delivery of the pump 1 (the direction of gas circulation is illustrated by the arrows G in FIGS. 1 and 2).

The vacuum pump 1 is said to be “dry” because when operating, the rotors 10, 11 rotate inside the stator 2 without any mechanical contact, which allows the housings 3 to be free of oil.

At least one stator 2 of the vacuum pump 1 and/or at least one rotary shaft 8, 9 of the pump 1 is produced using two different materials, such as two types of cast irons, cast in two successive steps.

Thus, and with reference to FIGS. 2 and 3, at least one stator 2 of the vacuum pump 1 has an outer part of the stator 14 and a stator insert 15.

The outer part of the stator 14 is made of cast iron containing less than 5% nickel, such as containing less than 1% nickel. It is, for example, a spheroidal graphite cast iron, such as a ferritic cast iron also referred to as FGS cast iron, such as FGS 400-15 cast iron or ferrito-perlitic cast iron. According to another example, the cast iron containing less than 5% nickel is a silicon and molybdenum-based ductile cast iron (also called SiMo). These types of conventional, non-nickel enriched cast iron exhibit good mechanical strength.

The stator insert 15 contains at least 10% nickel, such as contains at least 30% or 35% nickel, such as at least 90% or 100% nickel.

It is, for example, a nickel-enriched cast iron, i.e. an alloy containing at least iron, carbon and nickel.

Nickel-enriched cast iron can be an austenitic spheroidal graphite cast iron, also referred to as FGS Ni-resist cast iron. This nickel-enriched cast iron is more resistant to corrosion than the cast iron forming the outer part of the stator 14 which contains traces of nickel, i.e. in quantity less than 5%, such as, for example, in the order of 0.02%.

According to another example, the cast iron containing at least 10% nickel is an austenitic cast iron with lamellar graphite, containing for example between 10% and 20% nickel, such as containing in the order of 13.7%.

In addition to iron and nickel, nickel-enriched cast irons and non-nickel enriched cast irons contain at least 1% silicon and at least 1% carbon. These castings may also contain manganese, sulphur, phosphorus, copper, molybdenum and chromium, notably in quantities less than 10%.

According to another example, the stator insert 15 is an alloy containing at least 90% nickel.

According to another example, the stator insert 15 is made of nickel, i.e. containing substantially 100% nickel.

The stator 2 is thus formed from two solid parts of different materials. The core of the stator 2, which is likely to come into contact with the corrosive gases, is thus formed in a material that is more corrosion resistant. The material of the outer part 14, on the other hand, has greater mechanical strength. The vacuum pump thus has greater resistance to corrosive gases while exhibiting good mechanical strength. In addition, the use of nickel is targeted and therefore limited.

The outer part of the stator 14 can surround the stator insert 15, which ensures good mechanical strength, notably in the event of an overpressure or explosion in the pump 1. The outer part of the stator 14 thus has, for example, a general ring shape.

The enhanced mechanical strength of the outer part of the stator 14 can be used to arrange elements for fastening the stator 2 to another stator, such as threaded holes, in the outer part of the stator 14. The central housing 3 receiving the rotors 10, 11 and the orifices 16 of shaft passages 8, 9 opening into the central housing 3, are formed in the stator insert 15 (FIG. 3).

At least one interstage duct 13 communicating with the central housing 3 can also be at least partially arranged in the stator insert 15. In this example, the two lateral interstage ducts 13 are entirely arranged in the stator insert 15. According to another embodiment (not shown), the interstage ducts communicating with the central housing 3 are interposed between two successive pumping stages in the axial direction of the shafts 8, 9.

The surfaces of the central housing 3 and of the interstage ducts 13 in contact with the corrosive gases pumped thus have good corrosion resistance. Such a solid stator insert 15 makes it possible to protect against corrosive gases even in the case of superficial wall damaged, the corrosive gases continuing to be in contact with the nickel-enriched alloy or with the nickel. Furthermore, owing to this solid aspect of the stator insert 15, it is possible to remachine the parts possibly damaged during maintenance of the vacuum pump 1.

A single stator 2 of the vacuum pump 1 can thus be produced. It is preferably the stator 2 of the last pumping stage 1e, located on the delivery side of the vacuum pump 1. In the case where several stators 2 are produced like this, they are the adjacent pumping stages in the series, located on the delivery side of the vacuum pump 1, such as those of the last two or three pumping stages 1c, 1d, 1e. The pumping stages located on the delivery side are those which have the highest pressures and therefore face the greatest risks of corrosion.

All the stators 2 of all pumping stages 1a-1e can also be obtained in this manner.

During the manufacturing process of the stator 100, a stator insert 15 is formed comprising at least 10% nickel (step 101, FIG. 5), then an outer part of the stator 14, made of cast iron containing less than 5% nickel (step 102), is cast on the stator insert 15.

By casting the non-enriched nickel cast iron on the stator insert 15, the outer part of the stator 14 and the stator insert 15 are fused together locally on a fusion zone Zf of about 200 micrometres (see FIG. 4). During the casting operation, an intimate metallurgical bond is thus formed between the stator insert 15 and the outer part of the stator 14. This makes it possible to solve the problem of the different thermomechanical behaviours of the two materials. The metallurgical bond is thus extremely mechanically strong. This strong metallurgical bonding makes “release” of the two parts 14, 15 impossible.

In the case where a ferritic spheroidal graphite cast iron forms the outer part of the stator 14, the casting temperature of the ferritic spheroidal graphite cast iron may be greater than 1300° C., such as between 1300° C. and 1600° C., and more preferably between 1300° C. and 1400° C. The overmoulding by the outer part of the stator 14 can provide the energy to assist in the heat treatment of the stator insert 15.

Prior to moulding the outer part of the stator 14, the outer surfaces of the stator insert 15 are prepared to remove the mould residues (grains sand or other elements) and/or core residues so that the roughness of the outer wall of the stator insert 15 is for example between 6 and 12 micrometres, which corresponds to a coarse surface finish. The inventors have found that such a surface finish makes it possible to obtain better results, which is counter-intuitive.

Also, the outer wall of the stator insert 15 is advantageously free of threads, grooves, knurling or other elements with relief which could form holes or air gaps weakening the quality of the metallurgical bond between the outer part of the stator 14 and the stator insert 15.

Furthermore, at least one rotary shaft 8, 9 of the vacuum pump 1 can be formed from two different types of materials, such as two types of cast iron.

Thus, at least one rotary shaft 8, 9 has a shaft insert 17 made of cast iron containing less than 5% nickel and an outer part of the shaft 18 containing at least 10% nickel (FIG. 7).

The shaft insert 17 made of cast iron containing less than 5% nickel, such as containing less than 1% nickel, is a ferritic spheroidal graphite cast iron, for example.

The outer part of the shaft 18 containing at least 10% nickel, such as containing at least 30% or 35% nickel, such as at least 90%, may be, as described above for the stator insert 15, a cast iron alloy, such as an austenitic spheroidal graphite cast iron or may be 100% nickel.

The outer part of the shaft 18 is intended to bear at least one rotor 10, 11, such as a Roots type rotor, or having other forms, such as a threaded screw pump part.

The outer part of the shaft 18 may enter into contact with corrosive gases. It is therefore this part of the shaft 8 that is formed in more corrosion resistant material. The material of the shaft insert 17 has better mechanical strength, notably ensuring good flexural strength.

The shaft insert 17 is cast in the outer part of the shaft 18.

To do this, an outer part of the shaft 18 is formed in a general tubular shape containing at least 10% nickel (step 101, FIG. 5), and then a cast iron shaft insert 17, containing less than 5% nickel (step 102), is cast in the outer part of the shaft 18.

The outer part of the shaft 18 can radially surround the shaft insert 17. The outer part of the shaft 18 thus serves as a mould for the shaft insert 17 during the manufacture of the shaft 8, 9.

As for the stator 2, in the case where a ferritic spheroidal graphite cast iron forms the shaft insert 17, the casting temperature of the ferritic spheroidal graphite cast iron may be greater than 1300° C., such as between 1300° C. and 1600° C., and more preferably between 1300° C. and 1400° C.

In addition, before the moulding of the shaft insert 17, the roughness of the internal wall of the outer part of the shaft 18 is for example between 6 and 12 micrometres. The inner wall of the outer part of the shaft 18 is also preferably free of threads, grooves, knurling or other elements with relief which present a snagging risk.

The radial thickness d of the outer part of the shaft 18 may be greater than 0.5 cm, such as between 0.6 cm and 2 cm, which is relatively large compared to the few microns of the coating of the prior art deposited in thin layers. Such a solid outer part of the shaft 18 makes it possible to prevent corrosive gases from reaching the conventional cast iron in the event of mechanical impacts to the surface of the shaft 8, 9. On the contrary, in the event of impacts, the corrosive gases continue to be in contact with the nickel-enriched alloy or the nickel. The outer part of the shaft 18 can thus be subjected to small impacts and abrasions without lowering its level of protection against corrosive gases. Furthermore, owing to this solid aspect of the outer part of the shaft 18, it is possible to remachine the parts possibly damaged during maintenance of the vacuum pump 1.

The vacuum pump 1 features, for example, two rotary shafts 8, 9 produced in this manner, and two or three stators 2 on the delivery side produced in this manner.

The small volume rotors 10, 11 can be entirely made of a nickel-enriched alloy, such as cast iron containing at least 10% or 30% or 35% nickel, such as an austenitic spheroidal graphite cast iron or may be of nickel.

In this manner, it is possible to limit the formation of corrosion layers in the functional clearances between the stators 2 and the rotors 10, 11 which can lead to malfunctions of the vacuum pump 1. A vacuum pump 1 obtained in this manner is more resistant to corrosive gases, is not too expensive and has good mechanical strength.

1.-15. (canceled)

16. A stator of a dry vacuum pump, the vacuum pump comprising at least two rotors configured to rotate in a synchronised manner in opposite directions in a central housing of the stator and to drive a gas to be pumped between a suction inlet and a delivery outlet of the stator, the stator comprising:
an outer part made of cast iron containing less than 5% nickel; and
a stator insert wherein the central housing is arranged and is configured to receive the at least two rotors of the vacuum pump, the stator insert containing at least 10% nickel,
the outer part of the stator having been cast on the stator insert.

17. The stator according to claim 16, wherein the outer part of the stator surrounds the stator insert.

18. The stator according to claim 16, wherein at least one interstage duct communicating with the central housing is at least partially arranged in the stator insert.

19. The stator according to claim 16, wherein the stator insert is an alloy of cast iron selected from the group consisting of spheroidal graphite cast iron, cast iron containing at least 10% nickel, and cast iron containing at least 30% nickel.

20. The stator according to claim 16, wherein the stator insert is made of nickel.

21. The stator according to claim 16, wherein the outer part of the stator is made of a cast iron.

22. A dry vacuum pump having at least one pumping stage to drive a gas to be pumped between a suction inlet and a delivery outlet, the dry vacuum pump comprising at least one stator according to claim 16.

23. A method for manufacturing a stator of a dry vacuum pump, comprising:
forming a stator insert containing at least 10% nickel; and then
forming an outer part of the stator, made of cast iron containing less than 5% nickel, and casting the outer part on the stator insert.

24. A rotary shaft for a dry vacuum pump having at least one stator and at least two rotors configured to rotate in a synchronised manner in opposite directions in the stator and to drive a gas to be pumped between a suction inlet and a delivery outlet, the rotary shaft being configured to bear and drive in rotation at least one rotor, the rotary shaft comprising:
a shaft insert made of cast iron containing less than 5% nickel; and
an outer part of the shaft configured to bear at least one rotor of the dry vacuum pump, the outer part of the shaft containing at least 10% nickel,
the shaft insert having been cast in the outer part of the shaft.

25. The rotary shaft according to claim 24, wherein the outer part of the shaft radially surrounds the shaft insert.

26. The rotary shaft according to claim 24, wherein the outer part of the shaft is an alloy of cast iron selected from the group consisting of spheroidal graphite cast iron, cast iron containing at least 10% nickel, and cast iron containing at least 30% nickel.

27. The rotary shaft according to claim 24, wherein the outer part of the shaft is made of nickel.

28. The rotary shaft according to claim 24, wherein the shaft insert is made of spheroidal graphite cast iron.

29. A dry vacuum pump having at least one pumping stage to drive a gas to be pumped between a suction inlet and a delivery outlet, the dry vacuum pump comprising at least one rotating shaft according to claim 24.

30. A method for manufacturing a rotary shaft of a dry vacuum pump, comprising:
forming an outer part of the rotary shaft in a general tubular shape, the outer part containing at least 10% nickel; and then
forming a shaft insert, made of cast iron containing less than 5% nickel, and casting the shaft insert in the outer part of the rotary shaft.
